(19) United States
(12) Patent Application Publication
(10) Pub. No.: US 2004/0056485 A1
(43) Pub. Date: Mar. 25, 2004

(54) Integrally formed sheet metal tube flange

(75) Inventors: Kevin T. Love, Centerville, OH (US); John Randel Robison, Silvercreek, OH (US); Michael Ralph Storage, Beavercreek, OH (US); Antonio Salas Gonzalez, Beavercreek, OH (US); Mark Kevin Meyer, Centerville, OH (US)

Correspondence Address: Barbara Joan Haushalter, 228 Bent Pines Court, Bellefontaine, OH, 43311, US

(73) Assignee: General Electric Company

(21) Appl. No.: 10/251,534

(22) Filed: Sep. 20, 2002

(51) Int. Cl. F16L 17/00

(52) U.S. Cl. 285/363; 285/405; 285/406

(57) ABSTRACT

An integral sheet metal flange system for fluid ducts including a tubular base with an outwardly projecting annular clamping surface, and an inwardly projecting annular sealing face, wherein the inwardly projecting annular sealing face has a surface transverse to the longitudinal axis of the tube. The sheet metal flanges are made integral with the tubing and are comprised of aerospace alloys.

### BACKGROUND OF THE INVENTION

The present invention relates to a fluid duct system integrating a sheet metal flange design, and more particularly, to the combination of integrally flanged tubes and a sheet metal flange coupling providing a sufficient seal for a fluid duct system.

The application of tubular and piping ducts, as a conduit, is commonplace in the aerospace industry. The use of a duct system to transport fluids in a system has been well known in the industry for many years, but in this ever-changing environment, like most industries, technological advancements providing for quicker methods, and solutions, to problems are necessary for innovation. The present invention is one such innovation for the fluid conduit system of aerospace applications. The present invention uses an integrally formed sheet metal flange and coupling system, which provides numerous advantages when introduced into an aerospace vehicle.

A traditional method for adding such flanged ends on the tubular articles was to add a mechanical or thermal material joined processed end flange. This method for preparing the integrally flanged ends is unique in its application in that it is integrally formed onto the base tube with no mechanical or thermal material joining process required. The preparation of the present invention adheres to a mechanical manipulation of the original tubing, as opposed to mechanically or thermally joining separately formed flanges to the base tube.

It would be economically and technically desirable to provide an integrally formed sheet metal clamp coupling tube flange.

### BRIEF DESCRIPTION OF THE INVENTION

The integral nature of the present invention places more flexibility in the duct system as various tubular arrangements are connected and sealed, which is beneficial for a system exposed to high pressure and temperature fluctuations. The increased flexibility provides for less wear at the joints, providing a longer mechanical life for the duct system. The present invention also provides more flexibility in making the tubular articles, whereas mechanical or thermal material joining process joints were once used, the shape of the tube can be less expensively obtained. The numerous bends in the entire duct system have traditionally made it more difficult to use the mechanical or thermal material joining process flanges in a manner allowing for the duct to wrap around the vehicle. The present invention allows for more bends in developing the design structure that the tubular articles will follow around the system, which is beneficial to the production of the duct system and replacement parts because flange mechanical or thermal joining processes and subsequent inspection has been eliminated.

The benefits of this new invention include: reduced distortion caused by mechanical or thermal joining processes; reduced inspection effort; reduced part count and inventory, reduced manufacturing cost, reduced leakage possibility and improved reliability due to eliminated stress concentration caused by mechanical or thermal processes; and more design flexibility due to the flanges being axially shorter in length relative to mechanically or thermally joined flanges.

Accordingly, the present invention provides integral sheet metal flanges particularly suited for aerospace fluid duct systems. The flanges comprise a tubular base with an outwardly projecting annular clamping surface, and an inwardly projecting annular sealing surface, wherein the inwardly projecting annular sealing surface has a flat sealing face transverse to the longitudinal axis of the tube. The sheet metal flanges are made from tubing composed of high strength aerospace alloys. The present invention also provides for the manufacture of such integral sheet metal flanges for aerospace fluid duct systems.

### BRIEF DESCRIPTION OF THE DRAWINGS

FIG. 1 illustrates an initial tubular base material, prior to forming the integral sheet metal flanged ends;

FIG. 2 illustrates an outwardly projecting annular clamping surface formation indicating the expansion of metal walls at the end of the original tubular base, and also illustrates an inwardly projecting sealing face folded across the outwardly projecting annular clamping surface provided for by the present invention;

FIG. 3 illustrates an outwardly and inwardly projecting annular clamping surface and sealing face with corresponding angles; after final forming;

FIG. 4 illustrates a pair of integrally formed flanged ends placed face to face;

FIG. 5 is a tube axial view of a sheet metal flanged connection whereby seal of integrally flanged ends is ensured by a coupling; and

FIG. 6 illustrates a cross sectional view of the clamping apparatus for use with the integrally formed sheet metal clamp coupling tube flange;

FIG. 7 is a perspective view of a sheet metal flange and clamping system.

### DETAILED DESCRIPTION OF THE INVENTION

The term “integrally flanged tube,” as used herein, refers to any tube that has had its flanged end directly formed on the tube base material. The term does exclude any flanges added to the tube either through mechanical welding, bolting, thermal material joining or any method by which the flange was ever at any time separated from the tube. Also, the term, “fluid duct,” as used herein, describes the conduit system composed of piping or tubing in which a fluid can pass throughout a system.

In accordance with the present invention, the integral flanges can be formed using many of the commercially available metal forming techniques. Some possible techniques include hydraulic forming, plastic forming, rotary die forming, split die forming, or chemical or explosive forming.

In the typical hydraulic forming process, a tube is placed inside a die cavity. The die cavity is machined to produce the desired shape of the exterior surface of the final product. A fluid, liquid or gaseous, is injected into the inside of the tube. The pressure in the fluid is increased until the tube plastically deforms to take the shape of the die. Finally, the die, which is normally built in two halves, is opened up to remove the finished part.

The plastic forming process is fundamentally the same as the hydraulic forming process. The only difference is that an elastomer is placed on the inside of the tube and then force is applied to its ends. This, then, forces the metal tube into the die as the pressurized fluid did in the previous method.

The rotary die forming process is also similar to the hydraulic forming method in that external split dies and tubes are employed. The difference is that a rotating tool is used to force the metal tube into the die cavity. The part removal process is the same as before. The split die process is significantly different than the prior methods in that no external die is necessary. Instead, an internal die is machined to produce the desired inside surface of the flange. The key aspect of this concept is that the internal form die must be divided into pie-shaped segments so that it can be collapsed to fit inside the tube prior to forming. These and other manufacturing methods can be used to form integral sheet metal flanges onto tubes.

Referring now to the drawings, FIG. 1 illustrates the initial tubular base 10, prior to forming the integral sheet metal flanged ends. The “tubular base” 10 refers to the initial tubing or piping parent material used to develop the integrally flanged tube. The tubular base 10 serves as the foundation for the structure disclosed by the present invention. In a preferred embodiment, the tubular base is constructed of a high strength aerospace alloy, such as is commonly used in the aerospace industry.

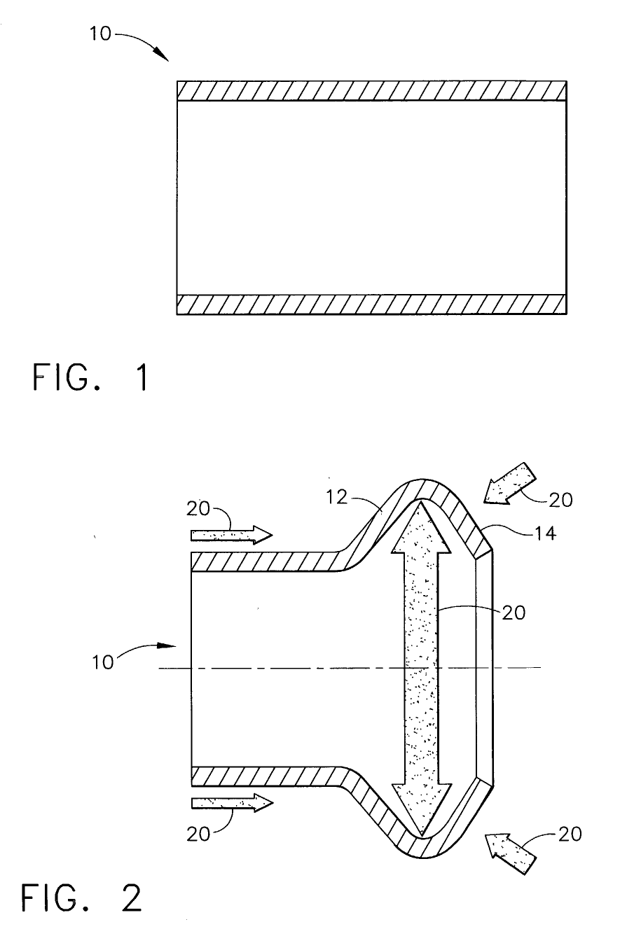

Referring now to FIG. 2, there is illustrated an outwardly projecting annular clamping surface 12 formation indicating the expansion of the metal walls at the end of the original tubular base 10. The term “outwardly projecting”, as used herein, describes the portion of the tubular base that has been directed away from its original longitudinal axis. The annular surface is a circular or predominantly circular shape, with the sealing surface being the portion of the tubular base that now forms the end of the redefined tube that will be used as part of the mechanism to seal the fluid duct system. The outwardly projecting annular clamping surface rises from the tubular base in which the flange is integrally formed. Arrows 20 indicate various forming forces.

Continuing with FIG. 2, there is also illustrated the process of turning the tubular base outward, wherein “turning” describes the process of forcing an end of the tubular base to have its V-shape formed. This causes a portion of the tubular base to fan out and run transverse to the longitudinal axis of the tubular base.

FIG. 2 also illustrates an inwardly projecting annular sealing surface 14. The inwardly projecting surface 14 is folded across the outwardly projecting clamping surface 12. The term “inwardly projecting,” as used herein, describes the portion of the tubular base 10 that has been directed toward its original longitudinal axis. The inwardly projecting annular surface 14 rises off perpendicular from the tubular base wherein it contacts the outwardly projecting annular clamping surface and has a flat surface transverse to the longitudinal axis of the tubular base. The term “off perpendicular,” as used herein, refers to the number of degrees that the inwardly projecting annular sealing surface 14 is angled from a perfect right angle, or from the longitudinal axis of the tubular base. The longitudinal axis refers to the axis of the tubular base 10, running from the center of one end of the tubular base to the other end of the tubular base. In a preferred embodiment, the inwardly projecting annular sealing surface 14 rises a few degrees off perpendicular from the tubular base.

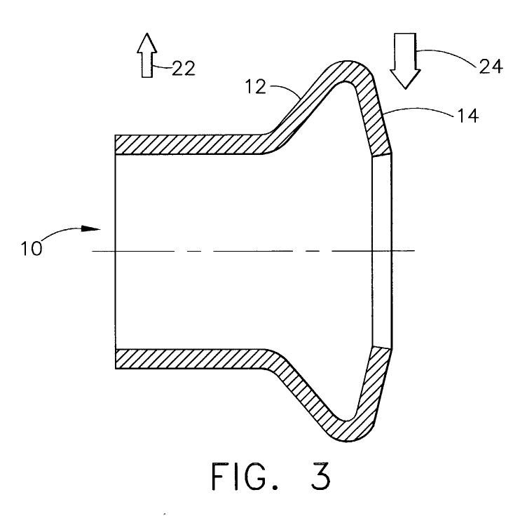

In FIG. 3, there is illustrated an embodiment of the outwardly and inwardly projecting annular surfaces with corresponding angles, with arrow 22 indicating direction of an outward force and arrow 24 indicating direction of an inward force. FIG. 3 illustrates that the outwardly projecting annular clamping surface 12 rises from the tubular base 10 in which the flange is integrally formed. In a preferred embodiment, the outwardly projecting annular sealing surface 12 rises from the tubular base. In FIG. 3, the inwardly projecting annular sealing surface 14 is illustrated as rising off perpendicular from the tubular base 10 wherein it contacts the outwardly projecting annular clamping surface 12 and has a flat surface transverse to the longitudinal axis of the tubular base 10. In a preferred embodiment of the invention, the inwardly projecting annular sealing surface 14 also rises off perpendicular from the tubular base 10.

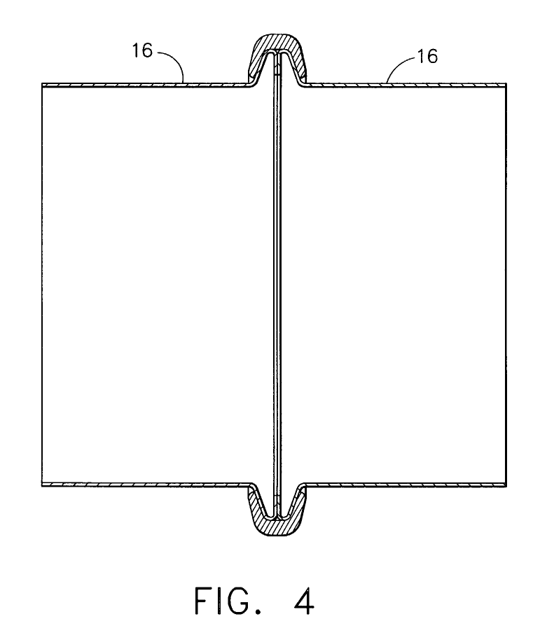

Referring now to FIG. 4, there is illustrated a cross section of a pair of integrally flanged tubes 16. The integrally flanged tubes 16 are placed end to end so that the surfaces of each inwardly projecting annular sealing surface are in contact. This allows for the clamping apparatus to simply envelop the flanged ends providing a sufficient seal at the connection without the need for separate flange welding.

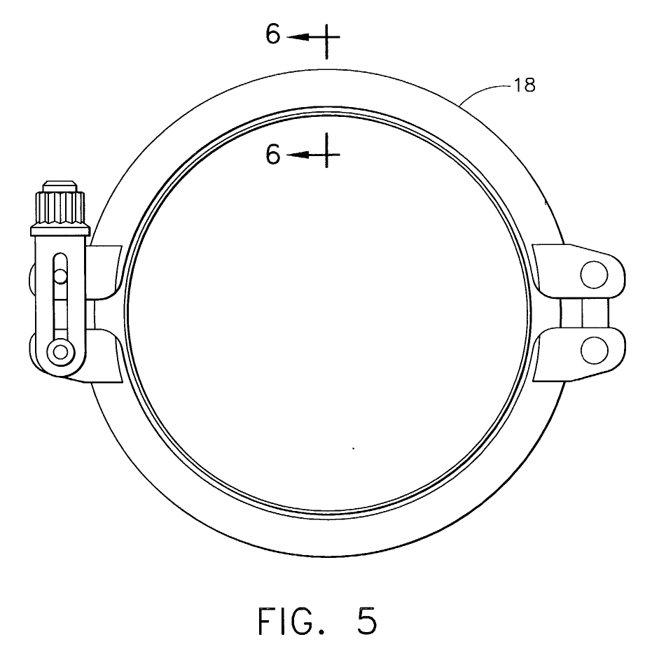

FIG. 5 shows an axial view of a clamping apparatus 18 that is known in the aerospace industry. The clamping apparatus is a coupling agent necessary to provide a quality seal between the two integrally flanged tubes. In a preferred embodiment of the invention, the clamping apparatus is a standard flange coupling.

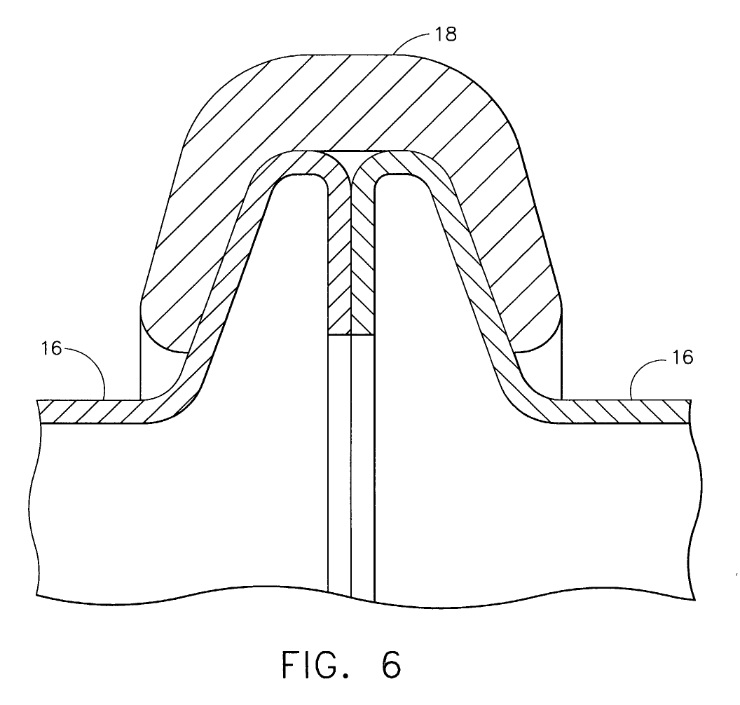

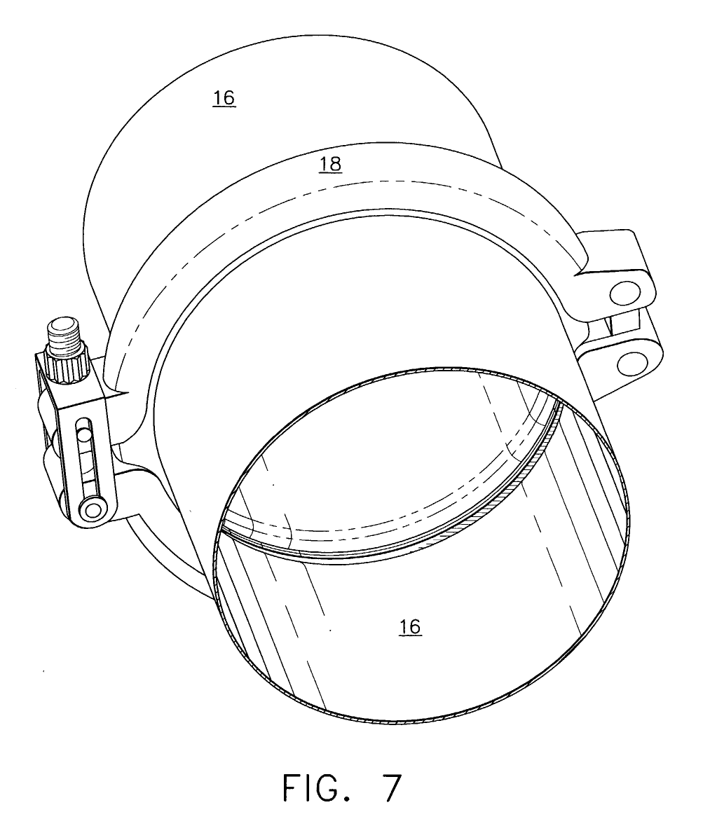

Continuing with FIG. 5 and referring also to FIGS. 6 and 7, there is illustrated in FIG. 6 a cross section view of a flanged connection. The coupling ensures seal of the integrally flanged ends. FIG. 6 shows two integrally flanged tubes 16 placed end to end so that the surfaces of each inwardly projecting annular flanges are in contact. A clamping apparatus 18 envelops the flanged ends. FIG. 7 illustrates a perspective view of the flange clamping system. A clamping apparatus allowing the flanged ends of the tubes to seal envelops two integrally flanged tubes 16.

While the invention has been described with reference to a preferred embodiment, it will be understood by those skilled in the aerospace industry that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An integrally flanged tube for a fluid duct system comprising:
(a) a tubular base;
(b) an outwardly projecting annular clamping surface rising from said tubular base; and
(c) an inwardly projecting annular sealing face rising off perpendicular axis from said tubular base, wherein said inwardly projecting annular sealing face may have a flat surface transverse to the longitudinal axis of the tube.

2. An integrally flanged tube according to claim 1 wherein said tubular base, said outwardly projecting annual clamping surface and said inwardly projecting sealing face are selected from a group consisting of high strength aerospace alloys.

3. An integrally flanged tube according to claim 2 wherein said outwardly projecting clamp surfaces rises from said tubular base.

4. An integrally flanged tube according to claim 2 wherein said inwardly projecting annular sealing surface rises perpendicular from said tubular base.

5. A method of preparing an integrally flanged tube for an aerospace fluid duct system, comprising the steps of:
(a) turning one end of a tubular base outwardly to provide an outwardly projecting annular clamping surface; and
(b) a wall of the tubular base formed back closely upon itself to provide an inwardly projecting annular sealing face extending beyond an inner wall of the tubular base to produce a sealing surface, transverse to the longitudinal axis of the tubular base, producing an opening about equal to an inner diameter of the tubular base.

6. A method of producing a clamping system comprising the steps of:
(a) placing at least two integrally flanged tubes together comprising a tubular base, an outwardly projecting annular clamping surface, and an inwardly projecting annular sealing face; and
(b) fastening said integrally flanged tubes with a clamping apparatus.

7. A method of manufacturing a clamping system according to claim 6 wherein a surface of said inwardly projecting annular sealing face of one said integrally flanged tube contacts a surface of said inwardly projecting annular sealing face of another said integrally flanged tube.

8. A method of manufacturing a clamping system according to claim 7 wherein said clamping apparatus connects said inwardly and outwardly projecting annular surfaces of both said integrally flanged tubes.

9. A method of manufacturing a clamping system according to claim 8 wherein said clamping apparatus comprises a standard flange coupling.

10. An integral flange clamping system comprising:
(a) at least two integrally flanged tubes comprising a tubular base, an outwardly projecting annular clamping surface, and an inwardly projecting annular sealing face; and
(b) a clamping apparatus.

11. A clamping system according to claim 10 wherein a surface of said inwardly projecting annular sealing surface of one said integrally flanged tube contacts a surface of said inwardly projecting annular sealing surface of another said integrally flanged tube.

12. A clamping system according to claim 11 wherein said clamping apparatus connects said inwardly and outwardly projecting annular surfaces of both said integrally flanged tubes.

13. A clamping system according to claim 12 wherein said clamping apparatus comprises a standard flange coupling.

14. A clamping system according to claim 13 wherein said clamping system comprises integral flange tubes constructed of aerospace alloys.
